(19) United States
(12) Patent Application Publication
(10) Pub. No.: US 2019/0000247 A1
(43) Pub. Date: Jan. 3, 2019

(54) Air Cushion Type Independent Pocket Spring Structure

(71) Applicant: Fu-Chung Ko, Taichung City (TW)

(72) Inventor: Fu-Chung Ko, Taichung City (TW)

(21) Appl. No.: 15/873,889

(22) Filed: Jan. 17, 2018

(30) Foreign Application Priority Data
Jul. 3, 2017 (TW) 106209694

(51) Int. Cl. A47G 9/10; A47C 27/10; A47C 7/02; A47C 7/14; B60N 2/70; B60N 2/90; B60N 2/72

(52) U.S. Cl. CPC A47G 9/1027; A47C 27/10; A47C 7/025; B60N 2/72; B60N 2/7094; B60N 2/914; A47C 7/14

(57) ABSTRACT

An air cushion type independent pocket spring structure, mainly being an independent pocket spring having a top cushion and a lower cushion; the top cushion and the lower cushion are respectively located in a top portion and a bottom portion of the independent pocket spring, and a plurality of the independent pocket springs are on a base. The independent pocket spring is compressible and resilient; wherein the independent pocket spring has an air inlet valve and an air outlet valve provided thereon; an air outlet tube is connected to the air outlet valve of the independent pocket spring and the air inlet valve of an adjacent independent pocket spring, and an air inlet tube is connected to the air inlet valve of the independent pocket spring and the air outlet valve of an adjacent independent pocket spring.

### FIELD OF THE INVENTION

The present invention relates to an air cushion type independent pocket spring structure, and more particularly to an independent pocket spring having a top cushion and a lower cushion being non-deformable and flat.

### BACKGROUND

Previously, it is known that the applicant has filed for a Taiwanese patent application with respect to an air cushion type independent pocket spring pillow structure, and the pillow structure comprises: “a top cushion, a lower cushion and a plurality of independent pocket springs; the top cushion and the lower cushion are respectively located in a top portion and a bottom portion of the pillow structure, and the plurality of independent pocket springs are distributed between the top cushion and the lower cushion; characterized in that: the independent pocket springs are compressible and resilient pocket springs located on a base cover, the base cover has a filter body therein and a non-return valve provided on a periphery thereof, a preset position on each of the independent pocket springs or the base cover has at least one air leakage hole; accordingly, when the pillow structure is pressed downwards by a human body, the independent pocket spring is compressed and air therein exits via the air leakage hole; when the pillow structure is not pressed downwards by the human body, the independent pocket spring returns to an original shape and external air enters into the filter body and then the independent pocket spring via the non-return valve, and the air therein is refreshed.”; the device is mainly used for filtering and refreshing; by using the weight of the human body to press and squeeze the pillow structure, the polluted molecules or unpleasant odors in the air are filtered and discharged; when the human body rolls over, the pillow structure returns to the original shape naturally, so that fresh air enters naturally, and fragrant odors can enable the muscles of the human body to relax; a natural fragrance is also disseminated to enable a person to be associated with the natural environment, so as to make the person feel refreshed and pleased; the shape and size thereof is the same as the usual beds, head pillows, slumber pillows, throw pillows, bed pillows, seat cushions and car pillows. The pillow structure does not take up excessive space and can be combined with a sensor and a modern electronic transmission mode, such that the duration and the intervals of a sleep time of a person can be transmitted to an electronic device such as a mobile phone after being sensed, and the sleep time can be recorded to serve as a basis for reference, or used to adjust the softness of the pillow structure; the pillow structure has received good reviews from the industry after introduction.

However, the related top cushion, the lower cushion and the independent pocket springs are formed integrally, and the top cushion and the lower cushion are made of a soft material; when air is filled in or leaked, the top cushion and the lower cushion are prone to becoming softened when placed under a heavy pressure, and the purpose of support cannot be completely fulfilled. Further, a plurality of independent pocket springs are adjacent to each other, and the adjacent independent pocket springs collapse together when placed under pressure, in which the uncompressed adjacent independent pocket springs are in an air-filled state, while the collapsed plurality of independent pocket springs do not provide the supporting strength, and the pillow structure becomes so soft that a pillow user feels like contacting with the bottom portion, and yet the uncompressed plurality of independent pocket springs are excessively filled, thus leading to the issue of unevenness in the pillow structure.

### SUMMARY OF THE INVENTION

In the prior application, the top cushion and the lower cushion of the air cushion type independent pocket spring do not completely fulfill the purpose of support when placed under a heavy pressure, in which the adjacent independent pocket springs collapse together and the collapsed plurality of independent pocket springs do not provide the strength of support, and the uncompressed plurality of independent pocket springs are excessively filled. The disparity therebetween is pronounced and if a user does not change the sleep posture after long hours of sleep, the body of the user would not be supported adequately, which may subsequently lead to muscle aches and affect the growth of a teenager during the developmental stage.

In light of such an issue, the inventor of the present application has made a great effort in development, research and improvement on the basis of the aforesaid disadvantage, and has finally come up with an invention for solving the aforesaid disadvantage after much trials, assembling and accumulation in experiences.

Accordingly, an air cushion type independent pocket spring structure is disclosed. In particular embodiments, the device relates to an air cushion type independent pocket spring structure, and more particularly to an independent pocket spring having a top cushion and a lower cushion being non-deformable and flat. when not compressed or under the air pressure from other independent pocket springs, the top cushion slowly rises without deformation; when air exits from the independent pocket spring, the top cushion slowly drops without deformation. When a human body contacts and compresses a plurality of independent pocket springs, the independent pocket springs have adequate flexibility without collapsing completely, and a balance is achieved between the independent pocket springs, such that the occurrence of having the independent pocket springs in some areas over-tilted due to compression can be avoided, and the issue of having the independent pocket springs in an uncompressed area protruded excessively can be eliminated. The air cushion type independent pocket spring structure does not cause clear disparity in the tilting between the compressed and the uncompressed areas.

In some embodiments, the device comprises a top cushion, a lower cushion and a plurality of independent pocket springs, wherein the top cushion and the lower cushion are respectively located in a top portion and a bottom portion of each of the independent pocket springs, and the plurality of independent pocket springs are distributed on a base; the independent pocket springs may be compressible and resilient pocket springs; characterized in that: the top cushion and the lower cushion are made of a flat and non-deformable material; an independent pocket spring has an air inlet valve and an air outlet valve disposed on a periphery of a bottom thereof, and the air outlet valve of the independent pocket spring has an air outlet tube introduced into the air inlet valve of an adjacent independent pocket spring; the air inlet valve of the independent pocket spring has an air inlet tube communicated thereto, and the air inlet tube is connected to the air outlet valve of an adjacent independent pocket spring; accordingly, air from a compressed independent pocket spring is introduced into an adjacent independent pocket spring instead of flowing into an uncompressed independent pocket spring, so as to enable the independent pocket springs in a compressed area to have adequate flexibility without collapsing completely.

The present invention provides an air cushion type independent pocket spring structure, and an objective thereof is to provide an independent pocket spring having a top cushion and a lower cushion being non-deformable and flat; when not compressed or under an air pressure from other independent pocket springs, the top cushion slowly rises without deformation; when air exits from the independent pocket spring, the top cushion slowly drops without deformation.

The present invention provides an air cushion type independent pocket spring structure, and a further objective thereof is to provide an independent pocket spring having adequate flexibility without collapsing completely when a human body contacts and compresses a plurality of independent pocket springs, and a balance is achieved between the independent pocket springs, such that the occurrence of having the independent pocket springs in some areas over-tilted due to compression can be avoided, and the issue of having the independent pocket springs in an uncompressed area protruded excessively can be eliminated. The air cushion type independent pocket spring structure does not cause clear disparity in the tilting between the compressed and the uncompressed areas.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a schematic sectional view showing an uncompressed independent pocket spring according to the present invention.

FIG. 2 is a schematic sectional view showing a compressed independent pocket spring according to the present invention.

FIG. 3 is a schematic plane view showing the independent pocket springs assembled on a base according to the present invention.

FIG. 4 is a schematic plane view showing each of air outlet tubes and each of air inlet tubes connected to each of the independent pocket springs according to the present invention.

FIG. 5 is a schematic sectional view showing states of the compressed and the uncompressed independent pocket springs according to the present invention.

### DETAILED DESCRIPTION OF THE PREFERRED EMBODIMENTS

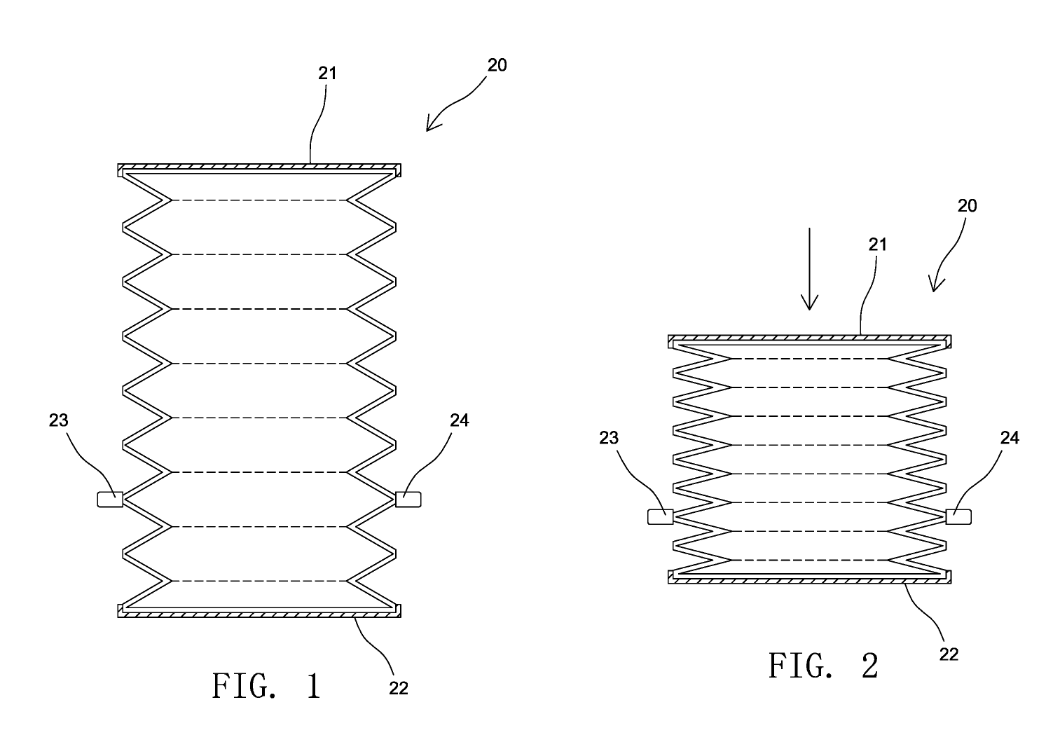

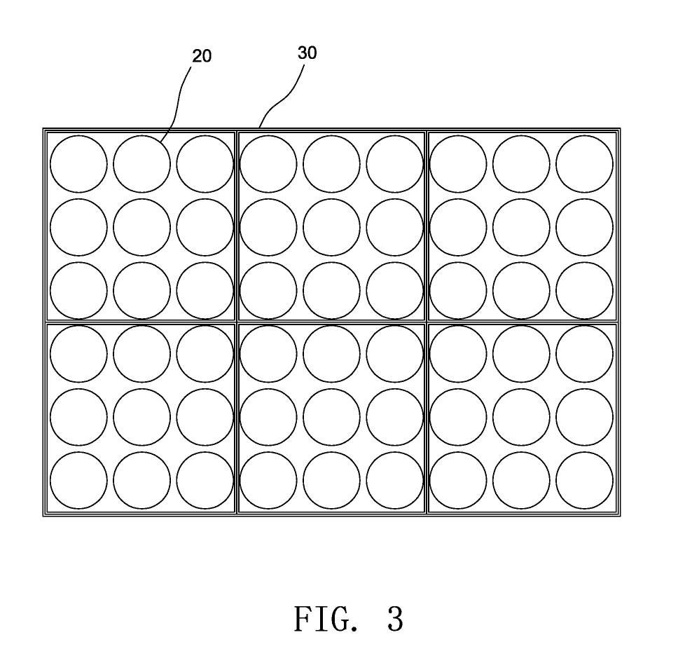

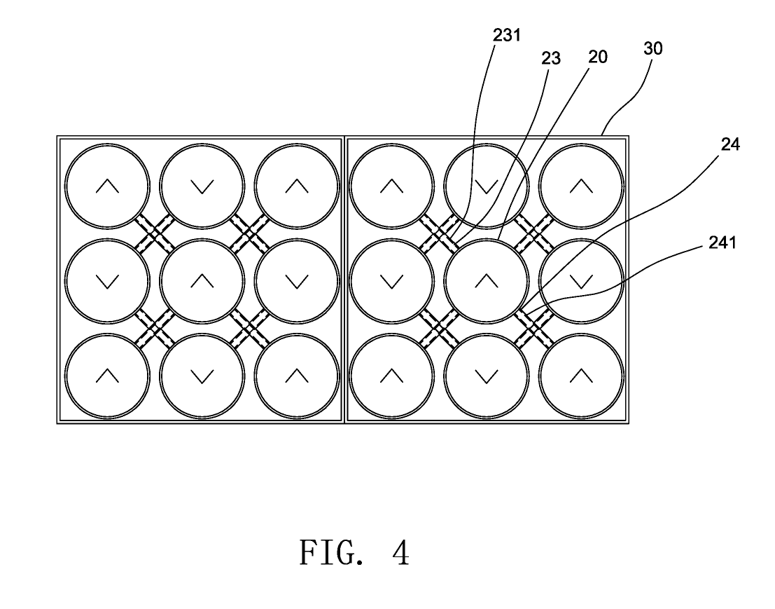

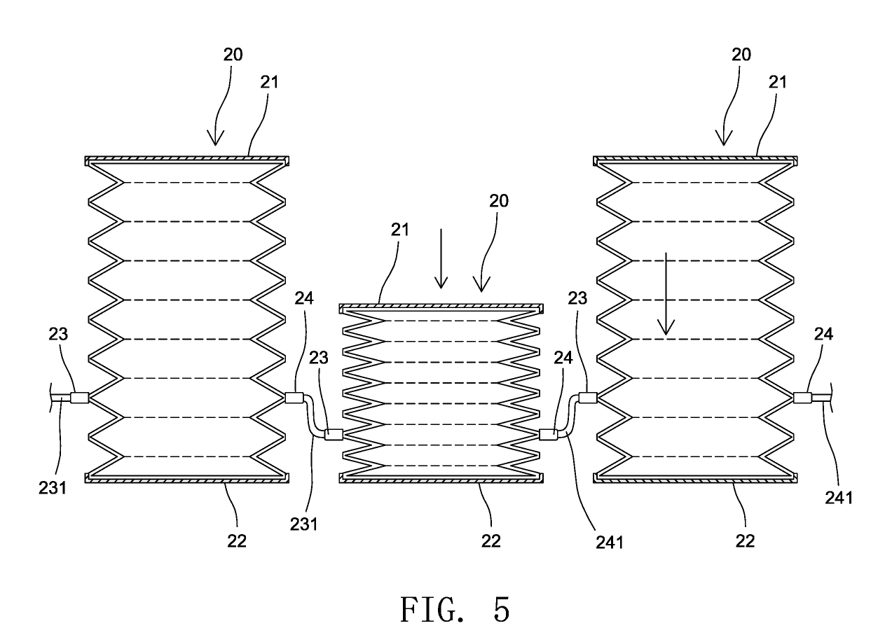

An air cushion type independent pocket spring structure according to the present invention, as shown in FIGS. 1, 2, 3, 4 and 5. An independent pocket spring 20 is mainly comprised of a top cushion 21, a lower cushion 22 and a base 30. A plurality of independent pocket springs 20 are placed on the base 30, and the top cushion 21 and the lower cushion 22 are respectively located in a top portion and a bottom portion of each of the independent pocket springs 20; each of the independent pocket springs 20 is a pocket spring having a serrated periphery and may be a compressible and resilient pocket spring made of a soft material. The top cushion 21 and the lower cushion 22 are flat and made of a non-deformable material, and is generally made of a slightly tougher material; each of the independent pocket springs 20 has an air inlet valve 23 and an air outlet valve 24 disposed on a periphery of a bottom thereof, and the air outlet valve 24 of the independent pocket spring 20 has an air outlet tube 241 connectingly provided thereon, the air outlet tube 241 is further connected to the air inlet valve 23 of an adjacent independent pocket spring 20; the air inlet valve 23 of the independent pocket spring 20 has an air inlet tube 231 communicated thereto, and the air inlet tube 231 is further connected to the air outlet valve 24 of an adjacent independent pocket spring 20 (as shown in FIGS. 4 and 5, the reversed “V” indicates the independent pocket spring 20 is rising, and “V” indicates the independent pocket spring 20 is dropping).

By using the aforesaid improved structure, the present invention provides an air cushion type independent pocket spring structure in which the independent pocket spring 20 can be used as a bed, a head pillow, a slumber pillow, a throw pillow, a bed pillow, a seat cushion and a car pillow; in addition to household uses, the present invention can also be used in cars. During use, the independent pocket spring 20 is pressed downwards by the weight of the body of a person (as shown in FIG. 5), in which a part of the independent pocket springs 20 are compressed, and air therein is discharged into an adjacent independent pocket spring 20 via the air outlet valve 24 instead of being discharged into uncompressed independent pocket springs 20; when the independent pocket springs 20 are not pressed downwards by the weight of the body of the person, that is, when the person rolls over or is not pressing on the independent pocket springs 20, the independent pocket springs 20 return to an original shape naturally, and air from the compressed independent pocket springs 20 is introduced into the adjacent independent pocket springs 20 instead of flowing into the uncompressed independent pocket springs 20, so as to enable the independent pocket springs 20 in a compressed area to have adequate flexibility without collapsing completely.

When each of the independent pocket springs 20 is compressed, the top cushion 21 and the lower cushion 22 have a force exerted thereon respectively, and the force is also exerted on the independent pocket spring 20. Because the top cushion 21 and the lower cushion 22 are both flat and made of a non-deformable material, the top cushion 21 slowly rises without deformation when not compressed or under an air pressure of other independent pocket springs 20, whereas the top cushion 21 slow drops without deformation when air exits from the independent pocket spring 20, such that when the body of the person contacts and presses on a plurality of independent pocket springs 20, the independent pocket springs 20 still have adequate flexibility without collapsing completely; a balance is achieved between the independent pocket springs 20, so that the occurrence of having the independent pocket springs 20 in a part of areas over-tilted due to compression can be avoided, and the issue of having the independent pocket springs 20 in an uncompressed area protruded excessively can be eliminated. The air cushion type independent pocket spring structure does not cause clear disparity in the tilting between the compressed and the uncompressed areas, which is an improvement over the prior application and is more applicable.

Similar to the prior application, the invention of the present application can also have multiple layers added to a bottom portion thereof for filtering air (a filter body, an activated carbon material, a fragrance), and the filter body and the activated carbon material used for filtering the impurities in the air can be various types of filter materials (such as bamboo charcoals), and then a fragrance is applied to disseminate a pleasant smell, thus enabling a person to be associated with the natural environment, so as to make the person feel refreshed and pleased.

Further, the compression and returning to an original shape for all of the independent pocket springs 20 are achieved by utilizing natural movements resulted from the weight of a person and rolling over of the person without requiring additional forces. When pressed by the weight of a person, internal air in an independent pocket spring 20 serially flows between the other independent pocket springs 20; moreover, the independent pocket spring 20 can be mounted with a sensor and combined with a modern electronic transmission mode, such that a duration and intervals of a sleep time of a person can be transmitted to an electronic device such as a mobile phone after being sensed, in order to record the sleep time to serve as a basis for reference.

It is of course to be understood that the embodiments described herein is merely illustrative of the principles of the invention and that a wide variety of modifications thereto may be effected by persons skilled in the art without departing from the spirit and scope of the invention as set forth in the following claims.

In summary, the present invention provides an air cushion type independent pocket spring structure having novelty, applicability and non-obviousness which are beyond doubt and satisfying the requirements for patent application, and thus an application has been filed accordingly.

What is claimed is:

1. An air cushion type independent pocket spring structure, comprising a top cushion, a lower cushion and a plurality of independent pocket springs, wherein, the top cushion and the lower cushion are respectively located in a top portion and a bottom portion of the independent pocket spring, and the plurality of independent pocket springs are distributed on a base; the independent pocket springs are compressible and resilient pocket springs; wherein the top cushion and the lower cushion are made of a flat and non-deformable material; the independent pocket spring has an air inlet valve and an air outlet valve disposed on a periphery of a bottom thereof, an air outlet tube is connected to the air outlet valve of the independent pocket spring and the air inlet valve of the adjacent independent pocket spring, and an air inlet tube is connected to the air inlet valve of the independent pocket spring and the air outlet valve of the adjacent independent pocket spring; accordingly, air from the compressed independent pocket spring is introduced into the adjacent independent pocket spring instead of flowing into the uncompressed independent pocket spring to enable the independent pocket springs in a compressed area to have adequate flexibility without collapsing completely.

2. The air cushion type independent pocket spring structure of claim 1, wherein the independent pocket spring is a pocket spring having a serrated periphery.
